(19) United States
(12) Patent Application Publication
(10) Pub. No.: US 2002/0113426 A1
(43) Pub. Date: Aug. 22, 2002

(54) Scuba checklist and method of advertising which incorporates a scuba checklist

(76) Inventor: D. Rich Lang, Atlanta, GA (US)

Correspondence Address: ROBERT R. WATERS, ESQ., WATERS LAW OFFICE, PLLC, 633 SEVENTH STREET, HUNTINGTON, WV, 25701, US

(21) Appl. No.: 10/118,367

(22) Filed: Apr. 8, 2002

Related U.S. Application Data
(63) Continuation-in-part of application No. 09/773,343, filed on Jan. 31, 2001.

(51) Int. Cl. B42D 1/00; B42D 5/00

(52) U.S. Cl. 281/15.1

(57) ABSTRACT

A checklist article is claimed which serves as a safety reference and a general information reference for scuba divers during the planning stages for a dive as well as during and after the dive. The reference information includes safety information, equipment maintenance information, dive tables and related information. The article is sized to conveniently be carried in a pocket and the pages of the article are made of a substance which will withstand underwater use. In addition, a method of advertising is disclosed whereby an advertising message is incorporated into a scuba checklist article in order to provide a means for commercial advertisers to target market products and services to divers and diving enthusiasts. The checklist article is designed to be retained and re-used on each dive, and therefore, the advertisement message, which is permanently incorporated into the checklist article, is reinforced. An advertisement article produced pursuant to the method is also claimed and may feature a variety of constructions and forms, as disclosed and claimed.

### CROSS REFERENCE TO RELATED APPLICATIONS

This application is a continuation-in-part of application 09/773,343 filed on Jan. 31, 2001.

### STATEMENT REGARDING FEDERALLY SPONSORED RESEARCH OR DEVELOPMENT

Not Applicable

### REFERENCE TO A MICROFICHE APPENDIX

Not Available

### BACKGROUND OF THE INVENTION

This invention relates generally to safety accessories for use by underwater divers or by instructors who are giving instruction to individuals who are learning to scuba dive. Specifically, this invention is directed to a safety checklist article for use by diving enthusiasts as a checklist while a dive is being planned, on the boat just prior to beginning a dive, and even during the dive. In addition, this invention relates to a direct method of advertising utilizing a printed scuba diving checklist in order to specifically direct the advertising message to the scuba enthusiast.

Scuba diving is a sport and recreation activity that is growing in popularity in the United States and much of the rest of the world. Each year, thousands of individuals take up scuba diving for the first time and receive instruction in scuba safety. These same individuals typically spend hundreds of dollars on scuba related gear and accessories. Due to the inherently dangerous nature of scuba diving, significant emphasis is placed on safety during instruction of beginning divers. Certainly, there is little room for error and since the life of the diver is at risk, diving students are trained not to take chances or cut corners on safety or safety equipment and supplies.

In order to dive safely, it is important that diving equipment and apparel be thoroughly inspected and properly maintained prior to any dive. In addition, it is important that divers understand scuba safety including what steps should be taken in the event a diving emergency occurs. Due to the importance of diving safety, training materials for diving students should include checklists and contingency supplies which enable the student to make fast and decisive choices in the event of an emergency.

For most divers, diving is undertaken during vacations, or at best, several times a year. Since diving activities can be infrequent, it is possible to forget or become unfamiliar with proper safety procedures and safety tips for safe diving. For this reason, it is important that divers, diving instructors, and new individuals taking up diving have effective reference materials at their disposal. Diving safety literature and articles are optimally re-used by the diver each time the activity is undertaken, and generally speaking, a diver will place great value on safety literature associated with diving. As such, it is safe to assume that diving literature such as safety guides, checklists, and the like will be retained and re-used each time diving activity is undertaken.

In scuba, just as in any sporting activity that incorporates specialized safety gear to address serious safety risks, care must be taken to maintain equipment and the proper steps to do so may not be obvious to the novice. One method of keeping track of various safety checks or steps that should be undertaken is to utilize a printed checklist. However, safety information has generally been left to the equipment designers, and a comprehensive commercially available checklist article for use by divers during dive planning, pre-dive and during a dive has not been available. Considering the importance of keeping scuba equipment in good shape, it would be very helpful to a diver to have a checklist that can be consulted to make sure all safety precautions have been taken. Optimally, such a checklist would be very complete and include all mechanisms and systems that should be checked before a dive begins, as well as how to properly store and maintain scuba gear.

In the United States, millions of dollars are spent each day on advertising. Advertising takes a wide variety of forms and permeates essentially all aspects of American life. Advertising displays can be found on billboards, taxi cabs, newspapers, and advertising messages are constantly beamed at consumers via radio, television, and more recently, the Internet. In view of the wide assortment of advertising media and the enormous dimension of the messages being sent to consumers, it is easy to surmise that advertising overload may be a problem. When consumers receive too many messages from too many sources, they easily learn to disregard all of them, or even subconsciously begin to do so. For the advertiser, it therefore becomes a more important challenge to specifically target its advertising dollars to reach the specific consumers who are most likely to be receptive to the message.

Another common feature of most printed advertisement media is the disposable nature of the article. Each day, we all see advertisements in newspapers as well as flyers, wrappers, and magazines. Quite frequently, the consumer will quickly skim the advertisement if they read it at all, and discard the paper article in the closest trash receptacle he or she can find. Accordingly, many advertising dollars are wasted, and the advertiser must compensate for this dilemma by printing and distributing even more of such articles such that the percentage of receptive viewers rises to an acceptable level. Of course, the waste of natural resources and disposal cost of unwanted advertising articles is also a consequent social cost for all of us to bear.

A preferred alternative for the advertiser is to place the advertisement on an article which the consumer will not want to throw away. This is specifically the case with reference material. For example, advertisements on the back of telephone directories are particularly effective because the consumer needs to retain the telephone directory and will make certain it is not discarded. In addition, each time the consumer reaches for the telephone book, his perception is often first captured by the advertisement on the back of the book. By receiving the same message over and over again, it is reinforced. Advertising on a multiple-use reference article is both more effective and less wasteful; accordingly, the advertising value is much greater.

Another problem facing commercial advertisers is the desire to target specific consumer demographics with the advertisement medium. For example, the marketer of high-end automobiles or sports cars will seek to aim advertisements at consumers with higher disposable incomes and accordingly, advertisements for luxury items are placed in magazines or other publications that are frequented by consumers of that demographic category. Therefore, an advertiser who wishes to reach consumers with high disposable incomes should specifically direct advertisements to an article to be viewed by those people, and for maximum efficiency, the advertisement should be placed on an article which the consumer will use repetitively and not throw away.

One market demographic that is particularly attractive to many advertisers is scuba enthusiasts. Generally speaking, individuals who scuba dive or participate in other such water sports tend to have higher incomes and an above-average spending lifestyle. Of course, since scuba diving is a vacation-type activity, it is common that a diver will be on vacation or otherwise far from home while engaging in the sport. In addition, since these individuals all share the common interest of scuba diving, advertisement of products which are best aimed at higher income individuals with an active lifestyle will be particularly effective with this group. The present invention specifically targets these consumers by placing an advertisement on a scuba safety checklist article, which is something that will generally be reviewed each time the article is used, and which will accordingly have a high personal value to the user.

### DESCRIPTION OF THE PRIOR ART

In the sport of scuba diving, safety is paramount and it is important to always have access to the appropriate reference information. Historically, one of the most important parameters to monitor is the rate of rise or descent in the water. This is because nitrogen narcosis is a real threat in situations where a diver allows himself to rise too quickly through the water. The U.S. Navy has long published a chart referred to as the “Navy Dive Tables” which sets safety maximums in the rate of ascent in order to avert nitrogen narcosis. In addition, diving groups such as PADI and others have occasionally published dive tables, in some cases setting a standard more conservative than the U.S. Navy tables. Such reference guides may be produced in booklet form or in the form of a card, and could conceivably be carried underwater. Such articles, however, have been limited in that the information provided is limited to only that of averting nitrogen narcosis and have not been directed to a wide range of reference information as is the case with the present invention. In addition, none have previously incorporated an advertising message. In fact, little attention has generally been given to the use of a safety checklist for the dual purposes of delivering a safety message and highlighting a product or service.

In the prior art, most safety devices directed to use by scuba divers are essentially underwater alarms or warning devices. For example, U.S. Pat. No. 5,506,571 by Dugan is a warning device to alert a diver of low air. The device is compact and functions to sound an audible alarm in the event of low air levels in the air tank. The Dugan device turns itself on and off utilizing a water conductivity activation switch. Although such instruments are useful, warning devices typically assist a diver once an emergency situation is encountered. It does not provide an underwater checklist reference guide for consultation by a diver. Likewise, U.S. Pat. No. 6,054,929 by Garofalo et al is a warning system for scuba divers which incorporates a wristband device which enables a warning of an emergency or dangerous condition to be relayed to other divers in a group. Garofalo is particularly useful during group dives in which one person in a group serves as an instructor for a number of others.

U.S. Pat. No. 4,882,678 by Hollis et al discloses a data sensing mechanism wherein a number of dive variables are measured, and information is transmitted to the diver for numerical and/or graphical display to permit a diver to make variable depth dives while maximizing the time spent under water. Specifically, Hollis is directed to a device which will assist divers in avoiding decompression sickness as body tissues become saturated with nitrogen as a result of water pressure during deep dives. Hollis includes a processor means for measuring air pressure in tanks as well as ambient hydrostatic pressure and dive time. In a similar vein, U.S. Pat. No. 4,586,136 by Lewis discloses a digital computer for providing a readout of tank pressure depth and other variables of interest to the diver at any particular depth. While these devices are clearly needed, they are directed to measurement and alarms of specific dive parameters and do not function as a checklist reference guide.

Perhaps the closest prior art device found is U.S. Pat. No. 4,369,358 by Adams entitled “Table Correlating Device for Scuba Divers”. The Adams device is essentially a tubular element attached to the dive tank hose, and the apparatus correlates information from tables dealing with the rate of absorption of nitrogen in a diver's body. The device consists of two side-by-side outer tubes each having sight windows for selectively reading concentrically arranged tables. The tables contain information related to the amount of time a diver spends at various depths, decompression procedures, the surface interval between repetitive dives, and the resultant amount of nitrogen accumulated in the diver's body. Adams states that his device is an alternative to the carrying of dive tables and plastic information cards.

Looking outside the world of diving or water sports, the prior art features a wide assortment of patents which utilize alternative methodology to selectively deliver an advertising message to a user of a specified product. For example, U.S. Pat. No. 6,041,532 to Pollhaus et al. features a number of articles of household use such as lighters, bottle openers and writing instruments which are reconfigured as advertisement delivery messengers. Specifically, when the article is used in its normal operation, a switch is activated which operates a sound reproduction device incorporated therein, such as a microcassette player, to deliver a pre-recorded advertising message.

U.S. Pat. No. 6,148,484 to Andreae, Jr, features a clip article to be used by golfers to hold the golf score card in an otherwise conventional golf cart. In addition to providing a holding mechanism for the score card, the clip serves to target deliver an advertising message to the users. (See FIG. 2 of the patent) Likewise, U.S. Pat. No. 5,249,384 to Dark, Jr, discloses an apparatus and method for displaying an advertisement or other message inside a golf cup within a golf course.

Other unconventional advertisement delivery methods that direct target specific consumers during use include U.S. Pat. No. 5,415,541 to Stanton, as well as U.S. Pat. No. 5,373,653 to Suzuki, both of which claim variations of truck-mounted advertising systems. U.S. Pat. No. 5,642,484 to Harrison, III et al. features a “pump top” advertising display system for use at automated devices at point-of-sale locations, such as gasoline pumping stations. Adeseye claims a design for a combined lottery slip marking aid and advertisement display in Des. 413,932. Alternative advertising devices also appear in the prior art in conjunction with wall calendars, such as U.S. Pat. No. 6,138,391 to Ngan and Des. 391,991 to Conner.

The closest analogy to a scuba checklist may be an aviation checklist. Aviation checklists are highly formalized articles and the consultation of an aviation checklist is mandated by the Federal Aviation Agency (FAA). Advertising in an aviation checklist has only recently been undertaken, and is the subject of a co-pending patent application by the inventor of the present invention.

### SUMMARY OF THE INVENTION

The scuba checklist article claimed in this patent is the first scuba checklist designed and constructed to serve as a broad-based underwater reference guide. It is also the first such article to serve the added role of carrying an advertising message to the user. As a medium of advertising, it is unique in that the diver is a “captive market”—both in the sense that the article provides essential information that the diver has purchased, and also because the diver is essentially guaranteed to have consulted the article each time diving is undertaken. Accordingly, the primary objective of the present invention is to provide a direct access advertising article that will reach the diver during the period of time in which he or she is planning a dive or determining a dive sequence. Another key objective of the invention is to provide a reliable and effective methodology whereby an advertiser can target market goods or services to diving enthusiasts or diving instructors.

Another objective of the present invention is to create a scuba diving checklist which succinctly and effectively provides needed information to divers both before and during a dive. The checklist is compact enough to be taken along underwater, and the pages are constructed of a material which is tear resistant and which is not damaged by submersion under water.

Another objective of this invention is to create an advertising article which is not only re-usable, but essential to the targeted consumer such that the article is retained for use over and over again. By attaching the advertising message to a repeat-use article which has high strategic value to the user, protection, retention and re-use of the article will be greatly enhanced. As a result, the life-expectancy of the advertising article will be extensive.

Another primary objective of the present invention is to provide a scuba checklist/advertising article that is easy to manufacture. In the preferred embodiment of this invention, the backside of each page of the checklist serves as the advertising backboard. As a result, the added cost of including the advertisement on a scuba checklist is nominal.

Yet another objective of this invention is to construct a targeted advertisement medium to diving enthusiasts that will be sturdy and simple in construction. The present device achieves these purposes entirely.

As discussed above, the method of advertising and the diving checklist article of the present invention overcomes the disadvantages inherent in conventional scuba reference material and advertising media aimed at diving enthusiasts in a targeted and effective manner. In this respect, before explaining at least one embodiment of the invention in detail, it is to be understood that the invention is not limited in its application to the details of construction and to the arrangement of the advertising checklist article set forth in the following description or illustrated in the drawings. The invention is capable of other embodiments and of being practiced and carried out in various and diverse ways. Also, it is to be understood that the phraseology and terminology employed herein are for the purposes of description and should not be regarded as limiting.

Accordingly, those skilled in the art will appreciate that the concept upon which this invention is based may readily be utilized as a basis for the design of other structures, methods, and systems for carrying out the several purposes of the present invention. It is important, therefore, that the claims be regarded as including such equivalent constructions insofar as they do not depart from the spirit and scope of the present invention.

Furthermore, the purpose of the foregoing Abstract is to enable the U.S. Patent and Trademark Office and the public generally, and especially including the practitioners in the art who are not familiar with patent or legal terms or phraseology, to determine quickly from a cursory inspection, the nature and essence of the technical disclosure of the application. The Abstract is neither intended to define the invention of the application, nor is it intended to be limiting to the scope of the invention in any way.

### BRIEF DESCRIPTION OF THE DRAWINGS

Additional utility and features of this invention will become more fully apparent to those skilled in the art by reference to the following drawings, wherein the scuba checklist of the present invention is described more fully:

FIG. 1 is a front view of the front cover of a scuba checklist of the present invention shown in the closed position, and featuring the preferred embodiment wherein the article is pocket sized for convenience.

FIG. 2 is a front view of the scuba checklist of the present invention open to page one, and showing a graduated page sizing for ease in operation.

FIG. 3 is a front view of the scuba checklist of the present invention shown in the open position, with an advertisement placement as indicated.

FIG. 4 is a side view of the scuba checklist of the present invention.

FIG. 5 is a front view of a scuba diver shown with a scuba checklist of the present invention as shown.

### DETAILED DESCRIPTION

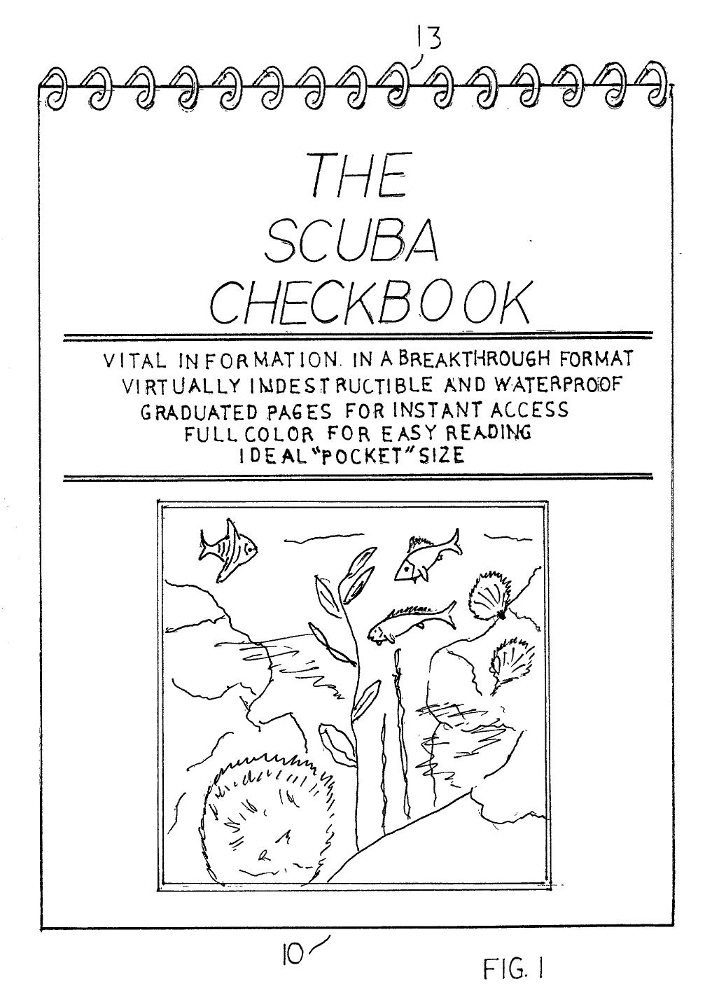

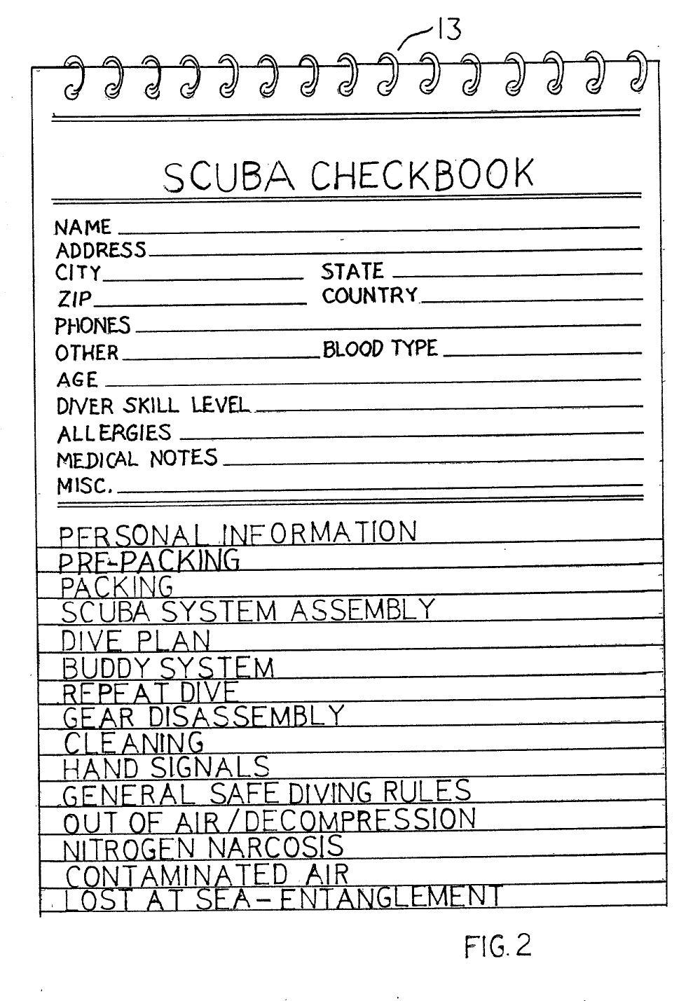

A scuba checklist of the present invention can take a variety of forms and constructions. A preferred variation of a scuba checklist article can be found in FIG. 1 and FIG. 2, which show a spiral-bound or helical-coil bound checklist Spiral binding is a very popular, well-known, conventional binding system, commonly used in situations in which the binding is meant to be permanent, without the need to add additional pages at a later date. The permanency and stability of a helical-coil binding also lends to the suitability of such a system for the scuba checklist. Although the spiral binding may be oriented vertically, along the side of the article for opening the pages like a conventional book, binding along the top may be preferred. Binding along the top facilitates carrying the article in a pocket as it would otherwise be possible to catch the tines or spiral binding on the side of the pocket.

As shown more clearly in FIG. 1, the checklist includes a first or front cover leaf 10 which defines a multiplicity of apertures along the topmost binding edge. The checklist is also characterized by a back cover and an assortment of interior pages 12 which also defines a multiplicity of apertures along the binding edge. The apertures along the binding edge of the aforementioned sheets are designed such as to line up with each other such as to receive a common binding element. The checklist features a helical-binding coil element 13 disposed along a coil axis, such that the turns of the coil element travel through the multiplicity of apertures of the checklist pages, thereby attaching the same in a spiral-bound notebook-type assembly. Most such coil elements are usually comprised of a single, continuous wire element such as that shown in U.S. Pat. No. 2,228,355 to Key. However, other configurations are also possible such as a “Duo Wire” spiral binding offered by Akiles Products, Inc. of Ontario, Calif.

Another variation for binding of the checklist is a binding which features a tubular plastic member incorporating coaxial curled comb-like tine elements attached to a common elongated rib part. With this arrangement, the coaxial elements pass through respective slots (usually rectangular in shape) spaced along an edge of the sheets of paper. This type of binding is usually made of plastic and is generally known as a “plastic comb” binding, and is shown in U.S. Pat. No. 3,180,488 to Heusmann, which is incorporated herein by reference. As used hereafter, the term “spiral-binding” is intended to encompass either a wire helical binding or a plastic comb binding, both of which incorporate coaxial elements on a binding member.

With a spiral-bound mechanism, as one page of the article is turned, the back side of that page is exposed to the viewer and, accordingly, is an optimal location for an advertisement. As shown in FIG. 3, the advertisement would be placed on the back side of the scuba checklist pages for viewing as the article is being used. The scuba checklist shown in FIGS. 1 through 4 features a spiral binding located on the top edge of the sheets. Although not shown in the drawings, it is to be understood that other arrangements are also available such as a spiral binding located on the side “vertical” edge of the document, for somewhat of a traditional book format.

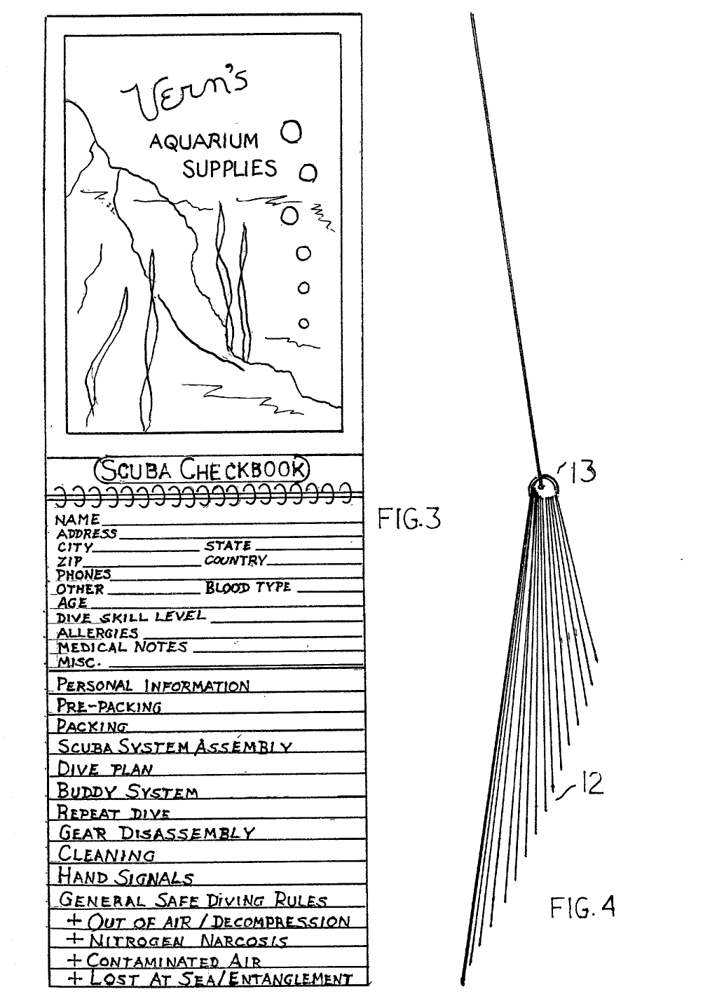

FIG. 4 shows a side view of a preferred embodiment of the scuba checklist article of the present invention. As shown in the drawing, the pages of the checklist article are graduated in length with the earlier pages of the article being shorter than latter pages. The graduation in the length of the pages is helpful in assisting the user to navigate within the device. Since the article may be used underwater, the pressure of the water may cause the pages to be difficult to turn without a graduated edge.

The different length pages each correspond to different sections of the booklet Furthermore, as shown in FIG. 3, the title of the page or the summary of the type of information found on that page or pages is summarized at the bottom of that page. Accordingly, the user may look to the graduated bottom portions of the checklist pages in order to quickly determine a topic of interest. This helps the user navigate through the article and obtain information faster. Although the pages are graduated in this preferred embodiment, it is understood that other means for navigating through the instrument are also possible.

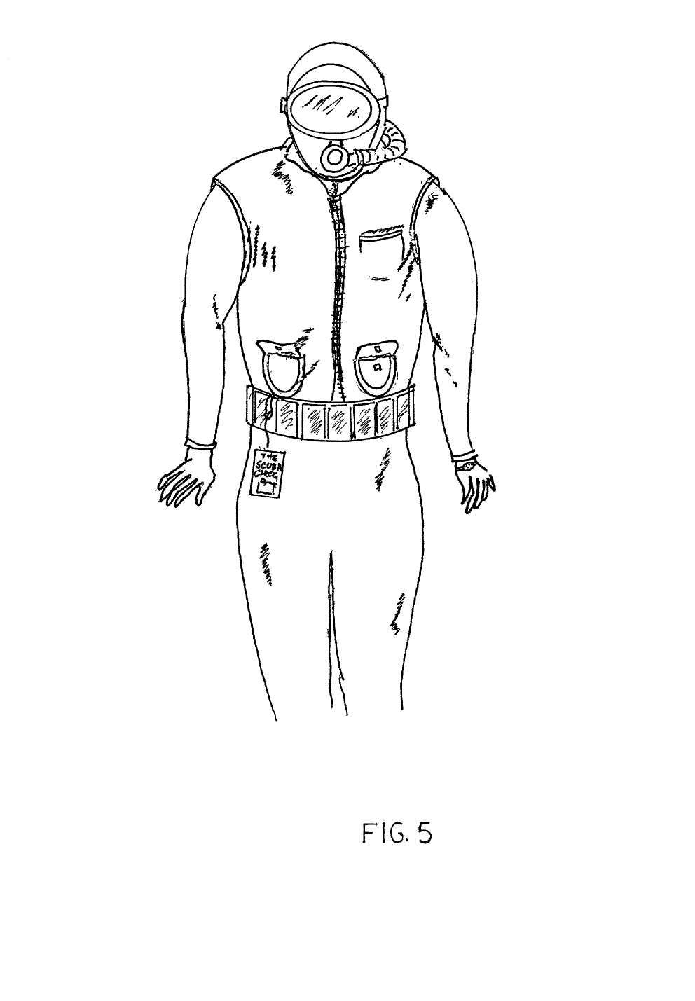

FIG. 5 shows a diver with the scuba checklist article. The drawing shows the article hanging from a tether line which is optional. In most cases, however, the article may be placed in a pocket in the diver's diving suit.

A scuba checklist of this invention may also be produced utilizing a wide assortment of conventional book binding means. These means could include adhesive binding, stitch binding, velobinding, thermal adhesives or any other conventional means. Of course, any binding mechanism employed must be able to remain unaffected by underwater use including usage in salt water.

Other embodiments are also within the scope of the claims of this invention. For example, while advertising panels may be located on the backsides of the checklist sheets as mentioned above, it also stands to reason that advertising panels may be located on the sides or edges of the primary checklist sheets themselves. In addition, the front and/or back covers could also be used as locations for advertising panels. In addition to advertisement panels or logos, other direct sales overtures are possible such as fold-out advertisement panels and/or coupons. Of course, since the scuba checklist may be used as a safety reference in times of an emergency, care must be taken to insure that safety is not compromised in the placement of advertisements. Key safety information must be easy to find and use in a hurry.

I claim:

1. A printed reference article containing reference information to be taken underwater by a diver for underwater use by a diver, and constructed such that the article can fit into a pocket.

2. The article of claim 1 wherein the article is a plastic or laminated card with information printed on one or both sides.

3. The article of claim 1 wherein the article is further characterized by the inclusion of one or more advertising messages located on one or both sides of said article, for communicating a message to the user of said article.

4. The article of claim 1 wherein the article is a multi-page notebook characterized by:
a. A printed notebook body comprising a first and second cover pages and one or more interior pages containing said information, located between said first and second cover pages; and
b. A binding means for binding together the cover pages and interior pages.

5. The article of claim 4 wherein the article is further characterized by the inclusion of one or more advertising messages located on one or more of said first and second cover pages and said interior pages, for communicating a message to the user of said article.

6. The article of claim 4, wherein said interior pages are constructed of paper, laminated paper, plastic, or any waterproof medium.

7. The article of claim 4 wherein said binding means is comprised of a helical binding coil element disposed along a coil axis, and wherein said first and second cover pages and said interior pages are further defined as including a multiplicity of binding apertures disposed along a binding edge of said pages with the spacing between said apertures corresponding to the spacing between the turns of said helical binding coil element.

8. The article of claim 4 wherein said binding means is comprised of a tubular plastic member incorporating coaxial curled comb-like tine elements attached to a common elongated rib part, wherein said cover pages and interior pages are further defined as including a multiplicity of binding apertures, and wherein said tine elements pass through said apertures to bind the pages together to form a notebook.

9. The article of claim 4 wherein the length of the cover pages and interior pages is graduated to correspond to sections of the multi-page notebook such as to assist in locating pages or sections of said multi-page notebook

10. The article of claim 5 wherein said advertising panels are located on the backside of said first or second covers or the backside of said interior pages.

11. The article of claim 5 wherein said advertising panels are located on the front side and along the edges of said first and second covers or the front side along the edges of said interior pages.

12. A method for delivery of an advertising message to a user of a diving or scuba checklist article comprised of:
a.) Placement of reference information useful to a diver during, before or after a dive on a laminated or plastic card constructed to fit into a diver's pocket; and
b.) Placement of one or more advertising messages on one or both sides of said reference article for communicating a message to the user of said article.

13. A method for delivery of an advertising message to a user of a diving or scuba checklist article comprised of:
a.) Assembly of a printed notebook body comprising a first and second cover pages and one or more interior pages located between said first and second cover pages and containing reference information useful to a diver during, before or after a dive;
b.) Binding together the cover pages and interior pages with a binding means; and
c.) Placement of one or more advertising messages on one or more of said first and second cover pages and said interior pages, for communicating a message to the user of said article .

14. The method of claim 13, wherein said interior pages of said article are constructed of paper, laminated paper, plastic or any waterproof medium.

15. The method of claim 13, wherein said binding means of said article is comprised of a helical binding coil element disposed along a coil axis, and wherein said first and second cover pages and said interior pages are further defined as including a multiplicity of binding apertures disposed along a binding edge of said pages with the spacing between said apertures corresponding to the spacing between the turns of said helical binding coil element.

16. The method of claim 13 wherein said binding means is comprised of a tubular plastic member incorporating coaxial curled comb-like tine elements attached to a common elongated rib part, wherein said cover pages and interior pages are further defined as including a multiplicity of binding apertures, and wherein said tine elements pass through said apertures to bind the pages together to form a notebook.

17. The method of claim 13 wherein said advertising messages are located on the backside of said first or second covers or the backside of said interior pages.

18. The method of claim 13 wherein said advertising messages are located on the front side and along the edges of said first and second covers or the front side along the edges of said interior pages.

19. The method of claim 13 wherein the length of the first and second cover pages and interior pages is graduated to correspond to sections of the multi-page notebook to assist in locating sections of information within said notebook.
